(19) United States
(12) Patent Application Publication
(10) Pub. No.: US 2003/0072376 A1
(43) Pub. Date: Apr. 17, 2003

(54) Transmission of video using variable rate modulation

(75) Inventors: Santhana Krishnamachari, Ossining, NY (US); Joseph P. Meehan, New York, NY (US); Robert A. Cohen, Troy, NY (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/976,338

(22) Filed: Oct. 12, 2001

(51) Int. Cl. H04N 7/12

(52) U.S. Cl. 375/240.26; 375/240.01; 375/240.12; 375/240.08

(57) ABSTRACT

A system and method for transmitting encoded video signals using a variable rate modulation scheme. In one embodiment a transmitter is provided comprising a system for partitioning the video into a plurality of streams; a system for determining a priority for each of a plurality of streams of encoded video data; and a system for assigning a different modulation rate to each stream of encoded video data based on the determined priority. Specifically, a lower, more robust, modulation is preferably used for higher priority streams, and a higher, less robust, modulation is preferably used for lower priority streams in such a way that an average rate is maintained.

### BACKGROUND OF THE INVENTION

1. Technical Field

The present invention relates to the transmission of encoded video, and more particularly relates to a system and method of transmitting MPEG video using variable rate modulation.

2. Related Art

As the demand for video applications delivered over both wireless (e.g., cellular) and wired (e.g., the internet) networks increases, the ability to efficiently transmit video data has become an important challenge. Some of the specific challenges that must be addressed include the large amount of bandwidth required for most video applications, the error-prone characteristics of the networks that deliver the video data, and the desire to transmit robust video images.

The bandwidth limitation is typically addressed by compressing video data using known encoding standards, including MPEG-2, MPEG-4, H.261, etc. Encoded video schemes, such as those provided by the MPEG standards can be partitioned into different streams of varying relative priority. The coded bitstream of video data can be partitioned based on, among other methods, the (a) frame type, such as the reference and motion predicted frames, (I, P and B), (b) header and non-header data, (c) base layer and one or more enhancement layer streams present in (temporal, spatial, SNR, or fine granular) scalable coded video, or (d) into video packets containing data corresponding to one or more macroblocks. Presently, when a video stream of frames is transmitted, a specific modulation scheme is selected (e.g., based on the channel conditions) and the whole stream is transmitted using the selected modulation scheme. Unfortunately, the inherent difference in the relative importance of the video frames is not exploited. Accordingly, using present-day systems, once a modulation scheme is selected, the overall robustness of the video image cannot be readily enhanced, and the ability to reduce transmission errors for high priority video data cannot be adequately addressed.

While many networking standards, including wireless, allow for the use of variable modulation schemes (and therefore variable transmission rates), none prescribe how to optimally select these available modulation schemes dynamically to match the characteristics of the data that is being transmitted. Accordingly, a need exists for a system that can take advantage of the variable modulation schemes available over most networks to improve the robustness of transmitting encoded video data.

### SUMMARY OF THE INVENTION

The present invention addresses the above-mentioned problems, as well as others by providing a system and method of transmitting streams of encoded video data using different modulation schemes, wherein the selection of the modulation schemes is based on a determined priority of each stream.

In a first aspect, the invention provides a system for transmitting encoded video signals, comprising: a system for partitioning encoded video data into a plurality of streams, a system for determining a priority for each of the plurality of streams of encoded video data; and a system for assigning a different modulation rate to each stream of encoded video data based on the determined priority.

In a second aspect, the invention provides an encoder for encoding and transmitting video data, comprising: a system for selecting a coding bit rate; a system for partitioning encoded video data into a plurality of streams; a system for determining a priority for each of a plurality of streams of encoded video data; and a system for assigning one of a plurality of possible modulation rates to each stream of encoded video data based on the determined priority.

In a third aspect, the invention provides a program product stored on a recordable medium, which when executed, includes a system for transmitting encoded video, the program product comprising: means for partitioning the encoded video into a plurality of streams; means for determining a priority for each of a plurality of streams of encoded video; and means for assigning a variable modulation rate to each stream of encoded video based on the determined priority.

In a fourth aspect, the invention provides a method of encoding and transmitting video data, comprising the steps of: selecting a coding bit rate between an upper and lower bound of an available set of modulation rates; encoding the video data at the selected coding bit rate; determining a priority for each of a plurality of streams of encoded video data; and assigning one of a plurality of possible modulation rates to each stream of encoded video data based on the determined priority.

In a fifth aspect, the invention provides a decoder for decoding encoded video data made up of different streams, wherein the different streams were transmitted using different modulation schemes determined based on a priority of each stream, and wherein the decoder includes a system for detecting and decoding the different modulation schemes.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a block diagram of a transmitter and receiver in accordance with a first embodiment of the present invention.

FIG. 2 depicts a block diagram of an encoder and decoder in accordance with a preferred embodiment of the present invention.

### DETAILED DESCRIPTION OF THE INVENTION

As will be described in more detail below, the invention utilizes variable rate modulation to provide the robust transmission of encoded video. To achieve this, an encoded video stream is divided into multiple streams of varying priority. Thus, for example, instead of transmitting all different priority streams using the same modulation (i.e., rate), a lower, more robust, modulation is preferably used for higher priority streams, and a higher, less robust, modulation is preferably used for lower priority streams. The increase in time required to transmit the higher priority streams at a lower rate is appropriately compensated by the decrease in the time required to transmit the lower priority streams at a higher rate. In this manner, the average transmission rate is maintained to be equal to a target rate that would be used if all the streams were transmitted with a single modulation. While the following embodiments generally describe systems that include two modulation rates (i.e., high and low), it should be understood that the invention could be practiced using any number of modulation schemes (e.g., very high, high, low, very low).

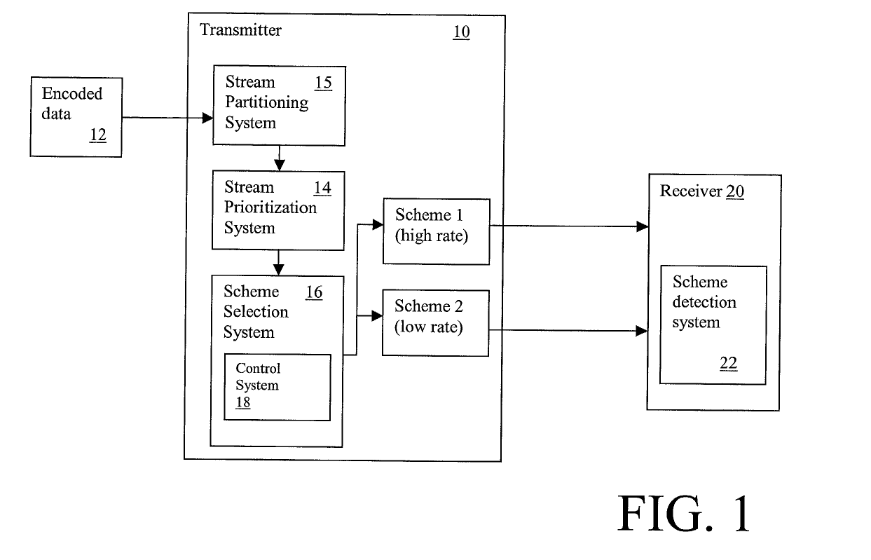

Referring now to the drawings, FIG. 1 depicts a transmitter 10 for transmitting encoded video data 12 to receiver 20. Encoded video data 12 may include any type of compressed or encoded video data, including, for example, MPEG-2, MPEG-4, H.261, H.263, H.26L, etc. After encoded video data 12 is received by transmitter 10, stream partitioning system 15 partitions the video data 12 into different streams based on a predetermined criteria. For example, partitioning may be based on: (1) the frame type (I, P and B frames); (2) header data and non-header data; (3) base layer and one of more enhancement layers (temporal, spatial, SNR, or fine granular) in scalable coded video; etc. It should be understood however, that any partitioning scheme that is known to one skilled in the art may be used.

After the streams are partitioned, they can be prioritized by stream prioritization system 14. Stream prioritization system 14 can prioritize streams in any manner. For example, in MPEG systems, I frames are generally more important than P frames, and P frames are generally more important than B frames. Accordingly, I frames could be assigned a higher priority than P frames, which could be assigned a higher priority than B frames. Similarly, header data could be assigned a higher priority than non-header data, and base layers could be assigned a higher priority than enhancement layers.

After the streams are prioritized, they are sent to scheme selection system 16, which assigns a modulation scheme to each stream. Scheme selection system 16 may include any scheme or standard that allows different modulation rates to be assigned when communicating data. For example, IEEE standards 802.11a and 802.11b, which are wireless local area network (LAN) standards that provide multiple modulation rates, could be utilized. In the generic example depicted in FIG. 1, there are two possible modulation schemes, scheme 1 (high rate) and scheme 2 (low rate). For example, scheme 1 could comprise a bit rate of 2 Mbits/sec, while scheme 2 could comprise a bit rate of 1 Mbits/sec. Many wireless networking standards allow for the use of variable modulation schemes, such as those proposed here. Accordingly, the details of such systems are presumed to be known by one skilled in the art and will not be described in further detail. Scheme selection system 16 assigns a scheme to a stream based on the determined priority of the stream. Specifically, for high priority streams, a low rate, more robust, scheme will preferably be assigned. For low priority streams, a high rate, less robust, scheme will preferably be assigned. Because the low rate modulation scheme sends the data more robustly, errors are less likely to occur than with a high rate modulation scheme.

For example, if the stream comprised an I frame, the stream would preferably be given a high priority and transmitted using scheme 2, i.e., a low modulation scheme. Note that because a lower rate is utilized to transmit the I frame (and I frames are generally larger than P and B frames), a significant increase in time to transmit the I frame may occur. This time increase may cause a problem since the coded video data typically must be transmitted within some predetermined delay constraint. The present invention offsets the time increase by sending lower priority streams at a higher rate modulation, i.e., using scheme 1. Thus, for example, P and/or B frames that are identified as low priority can be sent at a higher transmission rate, which will take a shorter period of time to transmit. As long as an average transmission rate for an entire set of streams is maintained at, or substantially conforms to, an acceptable target rate, predetermined delay constraints can be met. Similar methods for offsetting time increases for transmission of high priority streams could likewise apply to the other partitioning methods described above.

The process of ensuring that an average transmission rate is maintained at a target rate is handled by control system 18. Specifically, control system 18 can continuously monitor data streams being processed to determine if the target rate is being maintained, and cause scheme selection system 16 to make adjustments in the scheme selection process. For example, portions of a high priority stream could be sent using the low priority scheme (i.e., high rate) if there were not enough low priority streams available to meet the target rate.

On the receiving end, receiver 20 receives the variable rate streams. Scheme detection system 22 may be utilized to detect the different schemes and demodulate the streams accordingly.

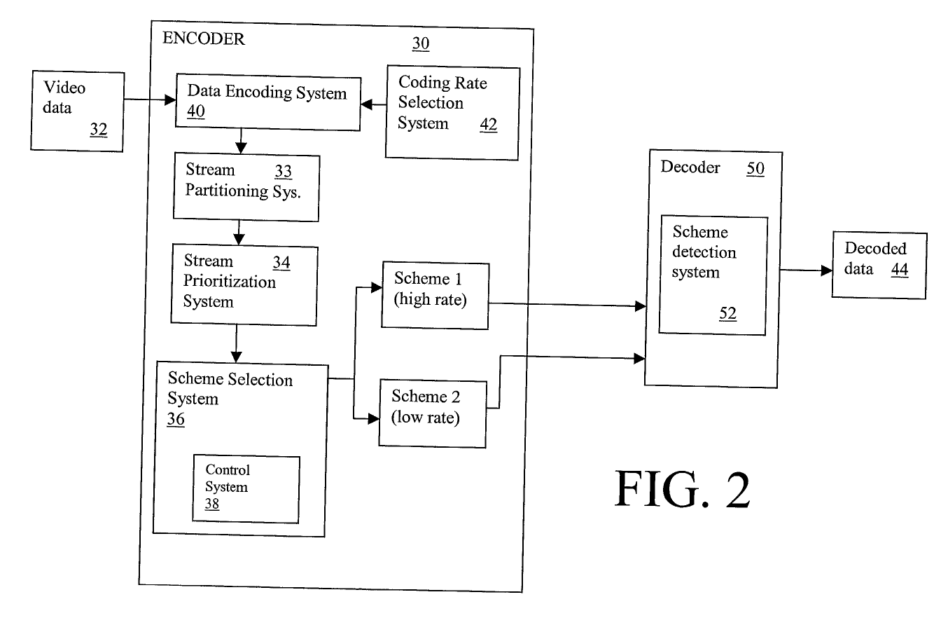

Referring now to FIG. 2, a second embodiment is shown comprising an encoder 30 for encoding and transmitting video data 32 to decoder 20. In this embodiment video data 32 is received and encoded by data encoding system 40 in any known manner, e.g., MPEG-2, MPEG-4, H.261, H.263, etc. As part of the encoding process, a coding rate is determined by coding rate selection system 42 to dictate the overall rate that encoded video data will be transmitted. The coding rate is preferably selected somewhere between the upper and lower transmission rate boundaries available for the transmission of the encoded data. For example, if a given protocol provided two transmission schemes at 1 and 2 Mbits/sec, the coding rate could be selected somewhere between 1 and 2 Mbits/sec, e.g., 1.5 Mbits/sec. The selected rate will depend on the relative rates of the low and high priority streams that are obtained after partitioning and prioritization.

Similar to the embodiment described with respect to FIG. 1, the encoded data is then partitioned and prioritized. Partitioning is handled by stream partitioning system 33, which could partition the encoded data into streams of data in any known manner, including those described above. Prioritization is handled by stream prioritization system 34 in any manner, including those described above. Scheme selection system 36 then assigns a modulation scheme to each stream based on the assigned priority of the stream, also in the same manner as described above. Thus, high priority streams (e.g., I frames) would preferably be assigned a low rate modulation scheme, while low priority streams (e.g., P and B frames) would preferably be assigned a high rate modulation scheme. In the example above, high priority data would be sent at 1 Mbits/sec, while low priority data would be sent at 2 Mbits/sec. Control system 38 would ensure that an average transmission rate of the transmitted streams adhered to the selected coding rate (e.g., 1.5 Mbits/sec). This scheme will result in a better video quality at the receiver, compared to transmitting either at 1 or 2 Mbits/sec. In the 1 Mbit/s case, although the transmission is very robust due to the low rate modulation, the reduced bit rate at which the video is coded reduces the video quality. In the 2 Mbit/sec case, although the source coded video quality is very good, the transmission errors caused by the high rate modulation transmission may result in a degradation of the received video quality. Selection of an intermediate rate and prioritized transmission offers a balance between the above two cases.

After the data was transmitted, decoder 50 would receive and decode the variable rate data. Decoder 50 comprises a scheme detection system 52 to determine which streams were decoded at which rate. Decoded data 44 would then be output.

It is understood that the systems, functions, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A system for transmitting encoded video signals, comprising:
a system for partitioning encoded video data into a plurality of streams,
a system for determining a priority for each of a plurality of streams of encoded video data; and
a system for assigning a variable modulation rate to each stream of encoded video data based on the determined priority.

2. The system of claim 1, wherein streams determined as having a relatively high priority are assigned a lower modulation rate than streams determined as having a relatively low priority.

3. The system of claim 1, wherein streams determined as having a relatively low priority are as signed a higher modulation rate than streams determined as having a relatively high priority.

4. The system of claim 1, further comprising a system that ensures that an average modulation rate substantially conforms to a predetermined target rate for the plurality of streams.

5. The system of claim 1, wherein the system for partitioning partitions the encoded video data based on a criteria selected from the group consisting of: distinctions between frame type, distinctions between header and non-header data, distinctions between base layer and enhancement layer streams present in a scalable coded video, and distinctions in video packets containing data corresponding to at least one macroblocks.

6. The system of claim 1, wherein the priority of each stream is determined based on an MPEG frame type, and wherein streams containing I frames are determined to have a relatively higher priority than streams containing P frames, and streams containing P frames are determined to have a relatively higher priority than streams containing B frames.

7. The system of claim 1, wherein the priority of a stream containing at least one macroblock is determined based on motion and texture information contained in the macroblock.

8. The system of claim 1, wherein the system for determining priority assigns a relatively higher priority to MPEG header data than it assigns to non-header MPEG data.

9. The system of claim 1, wherein the priority of a stream is based on base and enhancement layers, and wherein a relatively higher priority is assigned to base layers than is assigned to enhancement layers.

10. An encoder for encoding and transmitting video data, comprising:
a system for selecting a coding bit rate of the encoder;
a system for partitioning encoded video data into a plurality of streams;
a system for determining a priority for each of the plurality of streams of encoded video data; and
a system for assigning one of a plurality of possible modulation rates to each stream of encoded video data based on the determined priority.

11. The encoder of claim 10, wherein the plurality of possible modulation rates includes a low modulation rate below the coding bit rate and a high modulation rate above the coding bit rate.

12. The encoder of claim 11, wherein streams determined as having a relatively high priority are assigned the low modulation rate.

13. The encoder of claim 11, wherein streams determined as having a relatively low priority are assigned the high modulation rate.

14. The encoder of claim 11, further comp rising a system that ensures that an average modulation rate is maintained at the coding bit rate for the plurality of streams.

15. A program product stored on a recordable medium, which when executed, includes a system for transmitting encoded video data, the program product comprising:
means for determining a priority for each of a plurality of streams of encoded video data; and
means for selecting a modulation rate from a set of modulation rates for each stream of encoded video data based on the determined priority.

16. The program product of claim 15, further comprising encoding means that determines a coding bit rate of the plurality of streams, wherein the coding bit rate is selected between and upper and lower bound of the set of modulation rates.

17. The program product of claim 16, further comprising means for ensuring that an average modulation rate is maintained at the coding bit rate for the plurality of streams.

18. The program product of claim 15, wherein the assigning means assigns a higher modulation rate to lower priority streams and assigns a lower modulation rate to higher priority streams.

19. A method of encoding and transmitting video data, comprising the steps of:
selecting a coding bit rate between an upper and lower bound of an available set of modulation rates;
encoding the video data at the selected coding bit rate;
determining a priority for each of a plurality of streams of encoded video data; and
assigning one of a plurality of possible modulation rates to each stream of encoded video data based on the determined priority.

20. The method of claim 19, comprising the further step of:
ensuring that an average transmission rate each of the plurality of streams substantially conforms with the selected coding bit rate.

21. A decoder for decoding encoded video data made up of different streams, wherein the different streams were transmitted using different modulation schemes determined based on a priority of each stream, and wherein the decoder includes a system for detecting and decoding the different modulation schemes.
